(19) United States
(12) Patent Application Publication
(10) Pub. No.: US 2025/0272933 A1
(43) Pub. Date: Aug. 28, 2025

(54) MODEL-BASED PROCESSING TO REDUCE REACTION TIMES FOR CONTENT STREAMING SYSTEMS AND APPLICATIONS

(71) Applicant: NVIDIA Corporation, Santa Clara, CA (US)

(72) Inventors: Anjul Patney, Kirkland, WA (US); Amrita Mazumdar, San Francisco, CA (US); Andrew Ian Russell, Weston, FL (US); Kumaresan Gnanasekaran, Pune (IN); Seth Schneider, San Jose, CA (US); Rachel Brown, Portland, OR (US); Roland Tarrazo, Mountain View, CA (US); Shishir Goyal, Pune (IN); Ankan Banerjee, Bangalore (IN); Jason Mawdsley, San Jose, CA (US); Ariel Juan Bernal, Folsom, CA (US); Guillermo Siman, Mountain View, CA (US)

(21) Appl. No.: 18/800,563

(22) Filed: Aug. 12, 2024

Related U.S. Application Data
(60) Provisional application No. 63/556,397, filed on Feb. 22, 2024.

(51) Int. Cl. G06T 19/20; A63F 13/213

(52) U.S. Cl. CPC G06T 19/20; A63F 13/213; G06T 2219/2012

(57) ABSTRACT

In various examples, model-based processing to reduce reaction times for content streaming systems and applications is described herein. Systems and methods are disclosed that use one or more machine learning models to process image data representative of frames of an application, such as a gaming application, in order to generate updated imaged data representative of one or more updated frames that help reduce reaction times for users. For instance, the machine learning model(s) may update one or more visual characteristics associated with the frames, such as a contrast, a brightness, and/or a saturation associated with the frames. As described herein, the machine learning model(s) may be trained to update the frames in order to reduce the reaction times of users, such as by using one or more loss functions that measure loss in predicted reactions times and/or loss associated with visual characteristics of frames.

### CROSS-REFERENCE TO RELATED APPLICATIONS

This application claims the benefit of U.S. Provisional Application No. 63/556,397 filed on Feb. 22, 2024, which is hereby incorporated by reference in its entirety.

### BACKGROUND

For some gaming applications, the success of a player may be based on the player's reaction time, such as the time it takes for the player to observe what events are occurring with regard to a gaming application, process the events to determine how to respond, and then react with the determined response. Currently, there are many factors that may contribute to the player's reaction time, such as visual characteristics associated with frames being presented to the player. For instance, the contrast, brightness, saturation, and/or other visual characteristics of the frames may affect the player's reaction time. For example, if the visual characteristics include higher contrast levels, brightness levels, and/or saturation levels, then the player's reaction time may decrease as the player may more easily observe and process the events. However, if the visual characteristics include lower contrast levels, brightness levels, and/or saturation levels, then the player's reaction time may increase as it may be more difficult for the player to observe and/or process the events.

As such, some conventional systems may allow for players to set levels for various visual characteristics associated with gaming applications. For instance, a player may set a contrast level, a brightness level, and/or a saturation level that the conventional systems may then use when processing frames of a gaming application. For example, if the player increases the contrast level, the brightness level, and/or the saturation level, then the conventional systems may update the visual characteristics of the frames by increasing the contrast levels, the brightness levels, and/or the saturation levels associated with the frames. However, in some circumstances, while applying updates to visual characteristics for some frames may decrease the reaction times for players, the same static updates to visual characteristics of other frames may have the opposite effect of increasing reaction times. This is because the same static updates to visual characteristics may cause some events to be easier to observe in some frames while also causing other events to be more difficult to observe in other frames.

### SUMMARY

Embodiments of the present disclosure relate to model-based processing to reduce reaction times for content streaming systems and applications. Systems and methods are disclosed that use one or more machine learning models to process image data representative of frames of an application, such as a gaming application, in order to generate updated image data representative of one or more updated frames that help reduce reaction times for users. For instance, based at least on the processing, the machine learning model(s) may update one or more visual characteristics associated with the frames, such as contrast levels, brightness levels, and/or saturation levels associated with the frames. As described in more detail herein, the machine learning model(s) may be trained to update the frames in order to reduce the reaction times of users, such as by using one or more loss functions that measure loss in predicted reaction times and/or loss associated with visual characteristics of frames.

In contrast to conventional systems, such as those described above, the system of the present disclosure may dynamically update levels of various characteristics that are applied to frames using the machine learning model(s). For instance, and as discussed above, the conventional systems may apply the same, static levels of visual characteristics to all frames, which may decrease the reaction times for some frames, but may also increase the reaction times for other frames. In contrast, by dynamically updating the levels of visual characteristics using the machine learning model(s), individual frames and/or groups of frames may be updated using different levels of visual characteristics, such as respective contrast levels, brightness levels, and/or saturation levels, that are configured to reduce (e.g., minimize) the reaction times for at least a majority (e.g., all) of the frames.

### BRIEF DESCRIPTION OF THE DRAWINGS

The present systems and methods for model-based processing to reduce reaction times for content streaming systems and applications are described in detail below with reference to the attached drawing figures, wherein:

FIGS. 1A-1C illustrate examples of processes of using one or more machine learning models to process frames in order to reduce reaction times associated with an application, in accordance with some embodiments of the present disclosure;

FIG. 2 illustrates an example of using a filter to determine weights associated with frames, in accordance with some embodiments of the present disclosure;

FIG. 3 illustrates an example of a process of training one or more machine learning models to process frames in order to reduce reaction times associated with an application, in accordance with some embodiments of the present disclosure;

FIG. 4 illustrates an example of determining reaction times associated with a frame, in accordance with some embodiments of the present disclosure;

FIG. 5 illustrates a flow diagram showing a method for using one or more machine learning models to process frames in order to reduce reaction times associated with an application, in accordance with some embodiments of the present disclosure;

FIG. 6 illustrates a flow diagram showing a method for training one or more machine learning models to process frames in order to reduce reaction times associated with an application, in accordance with some embodiments of the present disclosure;

FIG. 7 is a block diagram of an example content streaming system suitable for use in implementing some embodiments of the present disclosure;

FIG. 8 is a block diagram of an example computing device suitable for use in implementing some embodiments of the present disclosure; and

FIG. 9 is a block diagram of an example data center suitable for use in implementing some embodiments of the present disclosure.

### DETAILED DESCRIPTION

Systems and methods are disclosed related to model-based processing to reduce reaction times for content streaming systems and applications. For instance, a system(s) may host a session of an application with a client device. As described herein, an application may include, but is not limited to, a gaming application, an interactive application, a multimedia application (e.g., a video streaming application, a music streaming application, a voice streaming application, a multimedia streaming application that includes both audio and video, etc.), a communications application (e.g., a video conferencing application, etc.), an educational application, a collaborative content creation application, or any other type of application. For instance, during the session, the client device may generate input data representing one or more inputs received from the user via one or more input devices. The system(s) may then receive the input data from the user, use the input data to update a state of the application, and then send content data (e.g., image data, audio data, etc.) representing the current state of the application back to the client device. Using the content data, the client device may then provide the content to the user, such as by displaying one or more frames depicting the current state and/or outputting sound associated with the current state. This process may then continue to repeat during the session associated with the application.

As described herein, the system(s) may process the image data using one or more machine learning models that are trained to update frames in order to reduce reaction times associated with users of applications. For instance, and for a frame, the system(s) and/or the machine learning model(s) may downsample the frame in order to generate a processed frame that includes a lower resolution than the original frame. The machine learning model(s) may then process the processed frame using one or more trained layers and, based at least on the processing, determine one or more weights associated with one or more initial lookup tables (LUT). In some examples, the machine learning model(s) may be configured to determine any number of weights associated with any number of initial LUTs, such as one weight associated with one initial LUT, two weights associated with two initial LUTs, three weights associated with three initial LUTs, five weights associated with five initial LUTs, and/or so forth. In some examples, the system(s) and/or the machine learning model(s) may then generate a final LUT by combining (e.g., concatenating, adding, fusing, etc.) the weight(s) associated with the initial LUT(s). The system(s) and/or the machine learning model(s) may apply the final LUT to the frame in order to generate an updated frame.

Additionally, or alternatively, in some examples, the system(s) and/or the machine learning model(s) may directly apply the initial LUT(s) to the frame in order to generate the updated frame. In such examples, the initial LUT(s) may be applied to the frame based at least on the weight(s) determined to be associated with the LUT(s). In either of the examples, by performing such processes, the final frame may include one or more values associated with one or more visual characteristics (e.g., a contrast, a brightness, a saturation, etc.) that cause the updated frame to be associated with a reaction time that is less than a reaction time associated with the original frame, which is described in more detail herein.

The system(s) may then continue to perform these processes of using the machine learning model(s) to process new frames in order to generate updated frames associated with the application. In some examples, since the system(s) process individual frames and/or groups of frames separately using the machine learning model(s), the updates applied by the machine learning model(s) to the frames may be dynamic such that the individual frames and/or the groups of frames include visual characteristics for reducing the reaction time of the user. Additionally, in some examples, and also based on processing the individual frames and/or the groups of frames separately, the machine learning model(s) may include one or more filters that are configured to ensure smoothness and/or consistency (e.g., temporal consistency) to the updates across the frames.

For instance, while updating the frames, the system(s) and/or the machine learning model(s) may further process the frames in order to determine color values (e.g., brightness values, etc.) associated with the frames, such as mean color values, mode color values, minimum color values, maximum color values, and/or any other color value. The system(s) and/or the machine learning model(s) may then determine whether there is a significant change in color between two consecutive claims using the color values. In some examples, the system(s) and/or the machine learning model(s) may determine whether there is a significant change based on tracking a mean color value between frames while performing the updating. For example, the system(s) and/or the machine learning model(s) may determine that there is a significant change when the color value associated with a frame differs from the mean color value by a threshold amount and/or determine that there is not a significant change when the color value does not differ from the mean color value by the threshold amount. While this is just one example technique of how the system(s) and/or the machine learning model(s) may determine when there is a significant change in color between consecutive frames, in other examples, the system(s) and/or the machine learning model(s) may use one or more additional and/or alternative techniques.

The machine learning model(s) may then use the determinations of whether there are significant changes in color when updating frames. For instance, and as described above, the machine learning model(s) may determine the weight(s) associated with the initial LUT(s). As such, in some examples, the machine learning model(s) may filter the weights over a period of time and/or over a number of frames, such as by continuing to update the weight(s) as new frames are received. For example, the machine learning model(s) may determine a first weight(s) associated with a first frame, determine a second weight(s) associated with a second frame by updating the first weight(s) using a new weight(s) determined for the second frame, determine a third weight(s) associated with a third frame by updating the second weight(s) using a new weight(s) determined for the third frame, and/or so forth. In other words, the machine learning model(s) may filter the weights associated with the frames such that the weights remain smooth between the frames (e.g., there are no large changes in colors between the frames).

As such, in some examples, if there is no significant change in color between two consecutive frames, then the system(s) and/or the machine learning model(s) may determine the filtered weight(s) associated with the subsequent frame by providing more weight (e.g., 90%) to the previously filtered weight(s) than the new weight(s) determined for the subsequent frame. In other words, if there is no significant change in color between two consecutive frames, then the system(s) and/or the machine learning model(s) may not change the weights for the frames by a large amount. However, if there is significant change in color between two consecutive frames, then the system(s) and/or the machine learning model(s) may determine the filtered weight(s) associated with the subsequent frame by providing less weight (e.g., 10%) to the previously filtered weight(s) as compared to the new weight(s) determined for the frame. In other words, if there is a significant change in color between two consecutive frames, then the system(s) and/or the machine learning model(s) may change the weights for the frames by a large amount. This way, when updating frames using one or more of the processes described herein, frames that are close in color with one another (e.g., there is no significant change) may include similar color characteristic levels applied during updating while frames that are not close in color with another (e.g., there is a significant change in color) may include different color characteristic levels applied.

As described herein, in some examples, the system(s) may train (e.g., update, etc.) the machine learning model(s) using one or more techniques such that the machine learning model(s) is able to update frames in a way that reduces reaction times of users. For instance, and for training data representing a training frame, the system(s) may apply the training frame to the machine learning model(s). The system(s) and/or the machine learning model(s) may then process the training frame using one or more of the processes described herein and, based at least on the processing, generate an updated frame corresponding to the training frame. The system(s) may then determine one or more losses using the training frame and the updated frame. For instance, in some examples, the system(s) may determine one or more first losses based at least on comparing the updated frame to a target frame (which may be represented by ground truth data) that is associated with the training frame. As will be described in more detail herein, the target frame may be similar to the training frame, but with being updated using one or more visual characteristics. For instance, the target frame may correspond to the training frame that is updated to include greater contrast, greater brightness, and/or greater saturation.

Additionally, or alternatively, in some examples, the system(s) may determine one or more second losses based at least on reaction times associated with the updated frame and the target frame. For instance, and as will be described in more detail herein, the system(s) may process the updated frame and, based at least on the processing, compute one or more first reaction time predictions associated with one or more points (e.g., one or more pixels) of the updated frame. Additionally, the system(s) may process the target frame and, based at least on the processing, compute one or more second reaction time predictions associated with the one or more points (e.g., one or more pixels) of the target frame (and/or the ground truth data may represent the second reaction time prediction(s)). The system(s) may then determine the second loss(es) based at least on the first reaction time prediction(s) and the second reaction time prediction(s).

The system(s) may then determine one or more total losses associated with the training frame using the first loss(es) and/or the second loss(es). Additionally, the system(s) may use the total loss(es) to update the machine learning model(s). For instance, in some examples, the system(s) may use the total loss(es) to update one or more parameters and/or weights associated with the layer(s) of the machine learning model(s) that is trained to determine the weight(s) associated with the initial LUT(s). Additionally, or alternatively, in some examples, the system(s) may use the total loss(es) to update the initial LUT(s) associated with the machine learning model(s). In any of the examples, the system(s) may then continue to perform these processes using one or more additional training frames and/or ground truth data corresponding to the additional training frame(s).

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems implementing vision language models (VLMs), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

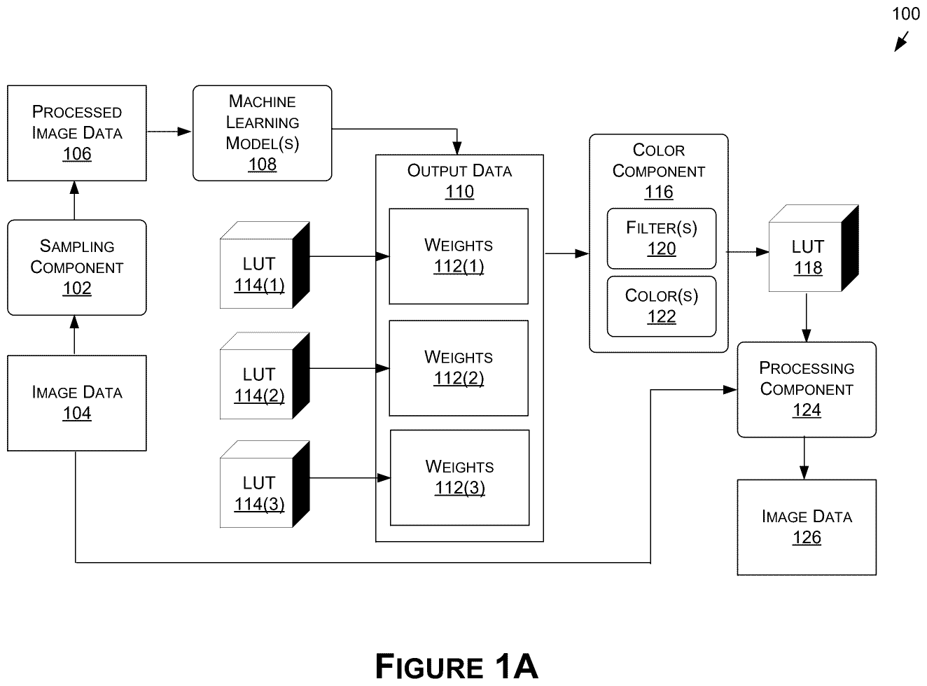

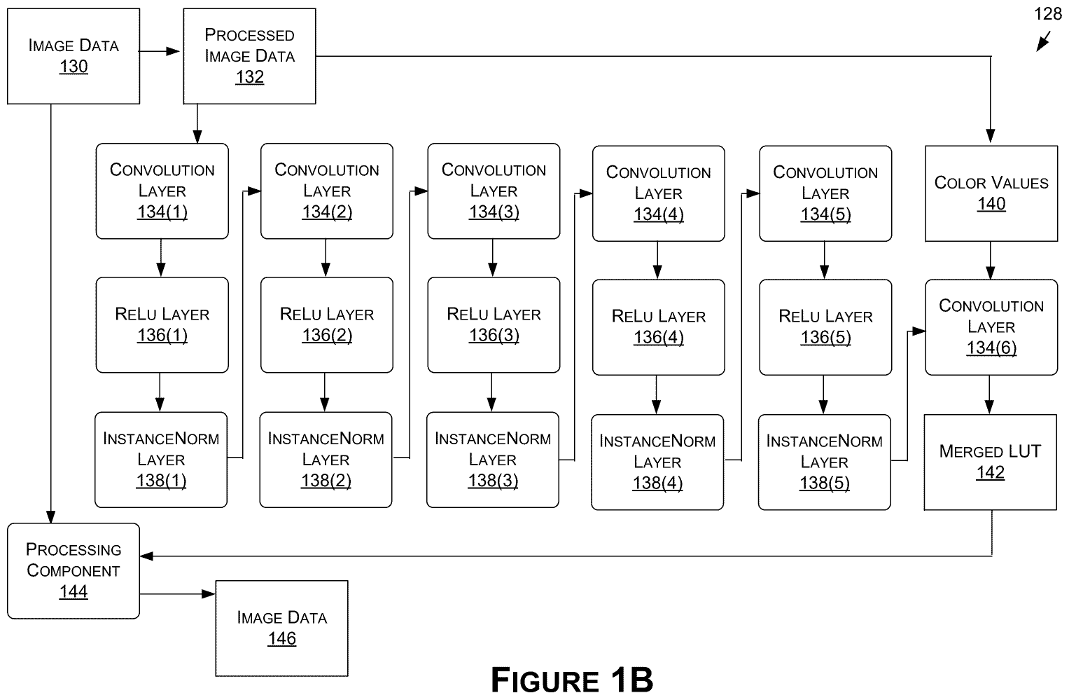

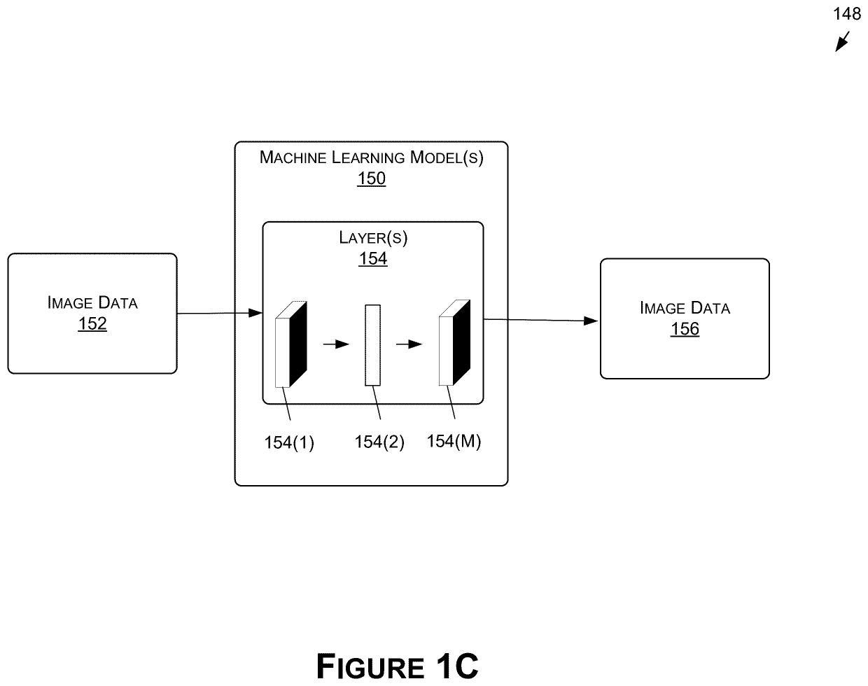

With reference to FIG. 1A, FIG. 1A illustrates an example of a process 100 of using one or more machine learning models to process frames in order to reduce reaction times associated with an application, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The process 100 may include a sampling component 102 receiving image data 104, where the image data 104 represents one or more frames associated with an application. For instance, one or more application servers (e.g., an application server(s) 702) may be providing the application to one or more client devices (e.g., a client device 704). As described herein, the application may include, but is not limited to, a gaming application, an interactive application, a multimedia application (e.g., a video streaming application, a music streaming application, a voice streaming application, a multimedia streaming application that includes both audio and video, etc.), a communications application (e.g., a video conferencing application, etc.), an educational application, a collaborative content creation application, or any other type of application. As such, the application server(s) may generate and then send the image data 104 for output by the client device. However, in order to help reduce the reaction times of one or more users associated with the application, the application server(s) and/or the client device may process the image data 104.

For instance, the process 100 may include the sampling component 102 processing the image data 104 in order to generate processed image data 106. In some examples, the sampling component 102 may process the image data 104 using one or more techniques, such as by downsampling one or more frames represented by the image data 104. For example, the frame(s) represented by the image data 104 may include a first resolution and the frame(s) represented by the processed image data 106 may include a second, lower resolution. As described herein, a frame resolution may include, but is not limited to, 256×256, 1920×1080, 2960×1440, 3840×2160, and/or any other frame resolution.

The process 100 may then include applying the processed image data 106 to one or more machine learning models 108. As described herein, the machine learning model(s) 108 may include, but is not limited to, one or more convolutional neural networks, one or more probabilistic neural networks, one or more feedforward neural networks, one or more deep stacking networks, and/or any other type of network. As shown, the process 100 may then include the machine learning model(s) 108 processing the processed image data 106 and, based at least on the processing, generating output data 110 associated with the image data 104. As shown, the output data 110 may represent weights 112(1)-(3) (also referred to singularly as “weight 112” or in plural as “weights 112”) associated with LUTs 114(1)-(3) (also referred to singularly as “LUT 114” or in plural as “LUTs 114”). While the example of FIG. 1A illustrates the machine learning model(s) 108 determining three weights 112 for three different LUTs 114, in other examples, the machine learning model(s) 108 may determine any number of weights associated with any number of LUTs.

As described herein, a LUT 114 may include a lookup table, such as a one-dimensional (1D) lookup table, two-dimensional (2D) lookup table, a three-dimensional (3D) lookup table, and/or any other type of lookup table that is used to transform one or more visual characteristics associated with the frame(s) represented by the image data 104. As described herein, a visual characteristic may include, but is not limited to, a contrast, a brightness, a saturation, a color, a sharpness, a tone, and/or any other visual characteristic. In some examples, the machine learning model(s) 108 and/or the LUTs 114 may be used to process image data 104 generated for a specific application. In some examples, the machine learning model(s) 108 and/or the LUTs may be used to process image data 104 generated for multiple applications. Still, in some examples, and as described more herein, the machine learning model(s) 108 and/or the LUTs 114 may be generated and/or updated during a training process associated with the machine learning model(s) 108.

For instance, and as shown, the process 100 may include a color component 116 using the weights 112 and the LUTs 114 to generate a LUT 118 that is used to then process the image data 104. In some examples, and for a frame, the color component 116 may generate the LUT 118 by combining (e.g., concatenating, adding, fusing, etc.) the LUTs 114 based at least on the weights 112. For example, the color component 116 may apply the first weight 112(1) to the first LUT 114(1) to generate a first output, apply the second weight 112(2) to the second LUT 114(2) to generate a second output, and also apply the third weight 112(3) to the third LUT 114(3) to generate a third output. In some examples, the color component 116 may then fuse (e.g., add, multiply, interpolate, and/or perform any other operation) the outputs in order to generate the LUT 118. As described herein, in some examples, since the machine learning model(s) 108 determines the weights 112 based on reducing reaction times, by performing these processes, the LUT 118 may thus be configured to update visual characteristics of the frame such that the frame is associated with a lower reaction time.

In some examples, and based at least on processing the individual frames and/or the groups of frames separately, the color component 116 may include one or more filters 120 that are configured to ensure smoothness, compatibility, and/or so forth to the updates across the frames. For instance, the color component 116 may process the frames represented by the image data 104 (and/or the processed image data 106) using a first filter 120 in order to determine color values 122 associated with the frames, such as brightness values. For example, the first filter 120 may track the mean color values 122, the mode color values 122, the minimum color values 122, the maximum color values 122, and/or any other type of color values 122 across the frames. As described herein, the first filter 120 may track the color values over a specific number of frames (e.g., one frame, ten frames, fifty frames, etc.) using a sliding window, over a specific period of time (e.g., one second, five seconds, ten seconds, etc.) using a sliding widow, continuously until detecting a significant change in color, and/or using any other technique.

The color component 116 may then use the first filter 120 to determine when there are significant changes in color associated with frames. For example, the color component 116 may determine that there is a significant change in color between two consecutive frames based at least on the color value 122 associated with the subsequent frame differing from the current mean color value 122 by a threshold amount, or determine that there is no significant change between the two consecutive frames based at least on the color value 122 associated with the subsequent frame being within the threshold amount to the current mean color value 122. While this is just one example technique of how the color component 116 may determine when there is a significant change in color between consecutive frames, in other examples, the color component 116 may use one or more additional and/or alternative techniques.

The color component 116 may then use the determinations of whether there are significant changes in color when updating frames. For instance, and for a current frame represented by the image data 104, the color component 116 may use a second filter 120 to determine final weights 112 to apply to the LUTs 114 using one or more previous weights 112 for one or more previous frames and current weights 112 determined for the current frame. As described herein, the second filter 120 may determine the weights 112 over a specific number of frames (e.g., one frame, ten frames, fifty frames, etc.) using a sliding window, over a specific period of time (e.g., one second, five seconds, ten seconds, etc.) using a sliding widow, continuously until detecting a significant change in color, and/or using any other technique.

For instance, the second filter 120 may blend the current weights 112 associated with the current frame with the previous weights 112 associated with the previous frames to determine final weights 112. When performing the blending, the second filter 120 may apply a greater weight to the previous weights 112 as compared to the current weights 112 when there is not a significant change in color associated with the current frame. For example, the second filter 120 may apply 90% (and/or any other percentage) to the previous weights 112 and 10% (and/or any other percentage) to the current weights 112 when there is no significant change in color. This way, the color processing performed on the current frame may be similar to the color processing performed on the previous frame in order to ensure smoothness, compatibility, and/or so forth to the updates across the frames. However, the second filter may apply a greater weight to the current weights 112 as compared to the previous weights 112 when there is a significant change in color associated with the current frame. For example, the second filter 120 may apply 90% (and/or any other percentage) to the current weights 112 and 10% (and/or any other percentage) to the previous weights 112 when there is a significant change in color. This way, the color processing performed on the current frame may be different from the color processing performed on the previous frame since the color (e.g., the brightness) between the frames is significantly different.

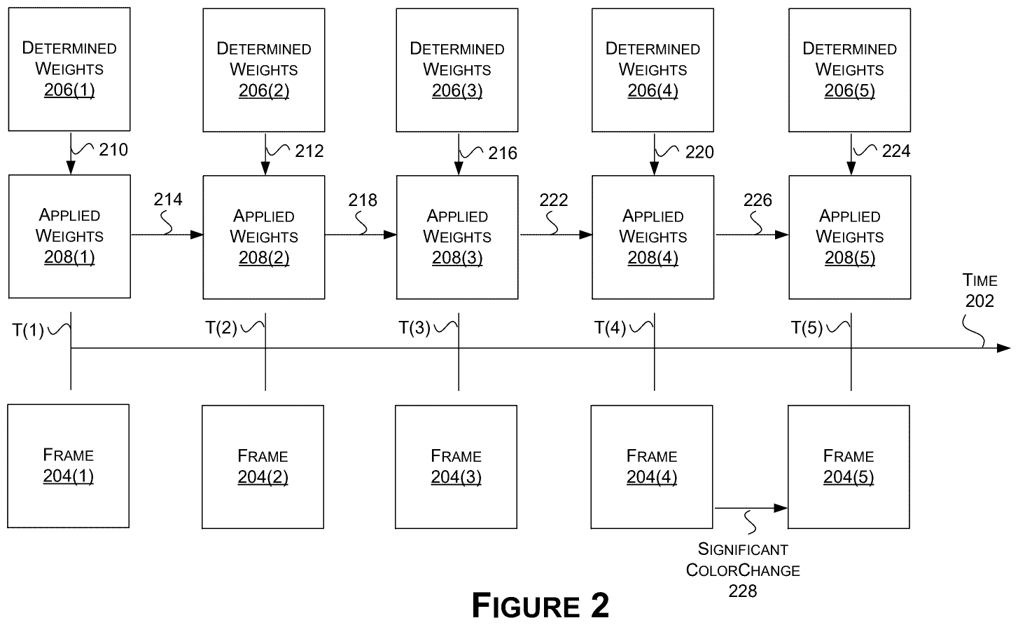

For instance, FIG. 2 illustrates an example of using a filter to determine weights associated with frames, in accordance with some embodiments of the present disclosure. As shown, over a period of time 202, frames 204(1)-(5) associated with an application may be processed. For instance, at a first time T(1), a first frame 204(1) may be processed in order to determine first weights 206(1) associated with the first frame 204(1), such as by using the machine learning model(s) 108. First applied weights 208(1) to use when processing the first frame 204(1) may then be determined using a weight 210 associated with the first weights 206(1). In the example of FIG. 2, the weight 210 may include 100% since the first frame 204(1) is an initial frame for the processing.

Next, at a second time T(2), a second frame 204(2) may be processed in order to determine second weights 206(2) associated with the second frame 204(2), such as by using the machine learning model(s) 108. Second applied weights 208(2) to use when processing the second frame 204(2) may then be determined using a weight 212 associated with the second weights 206(2) and a weight 214 associated with the first applied weights 208(1). In the example of FIG. 2, the weight 212 may include 10% and the weight 214 may include 90% since there is no significant change in color between the frames 204(1)-(2). Next, at a third time T(3), a third frame 204(3) may be processed in order to determine third weights 206(3) associated with the third frame 204(3), such as by using the machine learning model(s) 108. Third applied weights 208(3) to use when processing the third frame 204(3) may then be determined using a weight 216 associated with the third weights 206(3) and a weight 218 associated with the second applied weights 208(2). In the example of FIG. 2, the weight 216 may include 10% and the weight 218 may include 90% since there is no significant change in color between the frames 204(2)-(3).

Next, at a fourth time T(4), a fourth frame 204(4) may be processed in order to determine fourth weights 206(4) associated with the fourth frame 204(4), such as by using the machine learning model(s) 108. Fourth applied weights 208(4) to use when processing the fourth frame 204(4) may then be determined using a weight 220 associated with the fourth weights 206(4) and a weight 222 associated with the third applied weights 208(3). In the example of FIG. 2, the weight 220 may include 10% and the weight 222 may include 90% since there is no significant change in color between the frames 204(3)-(4). Finally, at a fifth time T(5), a fifth frame 204(5) may be processed in order to determine fifth weights 206(5) associated with the fifth frame 204(5), such as by using the machine learning model(s) 108. Fifth applied weights 208(5) to use when processing the fifth frame 204(5) may be determined using a weight 224 associated with the fifth weights 206(5) and a weight 226 associated with the fourth applied weights 208(4). In the example of FIG. 2, the weight 224 may include 90% and the weight 226 may include 10% since there is a significant change 228 in color between the frames 204(4)-(5).

In the example of FIG. 2, the determined weights 206(1)-(5) and/or the applied weights 208(1)-(5) may represent, and/or include, the weights 112. Additionally, while the example of FIG. 2 describes using percentages that include 10% and 90%, in other examples, any other percentages may be used when performing the processes described herein.

Referring back to the example of FIG. 1A, the process 100 may include a processing component 124 using the LUT 118 to transform a frame represented by the image data 104 into an updated frame represented by image data 126. As described herein, the processing component 124 may use any technique to transform the frame to the updated frame using the LUT 118. Additionally, the process 100 may continue to repeat such that one or more additional frames represented by the image data 104 are transformed into one or more updated frames represented by the image data 126. As described herein, by performing one or more of the processes described herein, the updated frame(s) may include on or more updated visual characteristics that cause the updated frame(s) to be associated with one or more reaction times that are less than one or more reaction times associated with the frame(s) before processing. Calculating reaction times associated with frames is described more herein with respect to at least the training (e.g., updating) of machine learning models.

While the example of FIG. 1A describes generating the final LUT 118 using the LUTs 114(1)-(3) and then using the final LUT 118 to transform the frame into the updated frame, in other examples, the process 100 may include directly applying the LUTs 114(1)-(3) to the frame. For instance, the processing component 124 may directly apply the LUTs 114(1)-(3) to the frame in order to transform the frame into the update frame represented by the image data 126. When directly applying the LUTs 114(1)-(3), the processing component 124 may use the weights 112(1)-(3) and/or the processing component 124 may not use the weights 112(1)-(2). In such examples, by performing such processes, the updated frame(s) may again include on or more updated visual characteristics that cause the updated frame(s) to be associated with one or more reaction times that are less than one or more reaction times associated with the frame(s) before processing.

FIG. 1B illustrates another example of another process 128 of using one or more machine learning models to process frames in order to reduce reaction times associated with an application, in accordance with some embodiments of the present disclosure. As shown, image data 130 (which may be similar to, and/or include, the image data 104) representing a frame of an application may be processed to generate processed image data 132 (which may be similar to, and/or include, the processed image data 106) representing a processed frame. For instance, and as described herein, the frame represented by the image data 130 may include a first resolution while the processed frame represented by the image data 132 may include a second, lower resolution.

The processed image data 132 may then be processed using multiple layers of a machine learning model(s), such as multiple convolution layers 134(1)-(6), multiple rectifier layers 136(1)-(5), and multiple instance normalization layers 138(1)-(5). While the example of FIG. 1B illustrates a specific number of the convolution layers 134(1)-(6), the rectifier layers 136(1)-(5), and the instance normalization layers 138(1)-(5), in other examples, the machine learning model(s) may include any number of convolution layers, rectifier layers, and/or instance normalization layers. Additionally, and as shown, the convolution layer 134(6) may receive a color value 140 associated with the frame, where the color value 140 may be similar to and/or include the color value 122. For example, the color value 140 may represent a mean color value associated with one or more frames being processed by the machine learning model(s). The convolution layer 134(6) may then perform one or more of the processes described above with respect to the color component 116 to update one or more weights associated with one or more LUTs using the color value 140.

The output from the convolution layer 134(6) may then include a merged LUT 142, which may be similar to and/or include the LUT 118. Additionally, a processing component 144, which may be similar to and/or include the processing component 124, may apply the merged LUT 142 to the image data 130 in order to generate image data 146, where the image data 146 may be similar to and/or include the image data 126. For instance, the processing component 144 may apply the merged LUT 142 to the frame in order to generate an updated frame represented by the image data 146. As described herein, by performing one or more of the processes described herein, the updated frame may include on or more updated visual characteristics that cause the updated frame to be associated with one or more reaction times that are less than one or more reaction times associated with the frame before processing. This process 128 may then continue to repeat for one or more additional frames represented by the image data 130.

FIG. 1C illustrates another example of another process 148 of using one or more machine learning models 150 to process frames in order to reduce reaction times associated with an application, in accordance with some embodiments of the present disclosure. The machine learning model(s) 150 may use the image data 152 (which may be similar to, and/or represent, the image data 104), without or without preprocessing, as an input. As described herein, the image data 152 may represent one or more frames, such as one or more frames associated with an application. In some examples, the image data 152 may be input as a single frame, or may be input using batching, such as mini-batching. For example, two or more frames may be used as inputs together (e.g., at the same time).

The image data 152 may be input into one or more 154 layers (1)-(M) (also referred to singularly as “layer 154” or in plural as “layers 154”) of the machine learning model(s) 150. The layer(s) 154 may include any number of layers, such as one layer, six layers, fifty layers, and/or so forth. One or more of the layers 154 may include an input layer. The input layer may hold values associated with the image data 152. For example, when the image data 152 represents a frame(s), the input layer may hold values representative of the raw pixel values of the frame(s) as a volume (e.g., a width, W, a height, H, and color channels, C (e.g., RGB), such as 32.times.32.times.3), and/or a batch size, B (e.g., where batching is used).

One or more layers 154 may include a convolutional layer. The convolutional layers may compute the output of neurons that are connected to local regions in an input layer (e.g., the input layer), each neuron computing a dot product between their weights and a small region they are connected to in the input volume. A result of a convolutional layer may be another volume, with one of the dimensions based on the number of filters applied (e.g., the width, the height, and the number of filters, such as 32×32×12, if 12 were the number of filters).

One or more of the layers 154 may include a rectified linear unit (ReLU) layer. The ReLU layer(s) may apply an elementwise activation function, such as the max (0, x), thresholding at zero, for example. The resulting volume of a ReLU layer may be the same as the volume of the input of the ReLU layer.

One or more of the layers 154 may include a pooling layer. The pooling layer may perform a down-sampling operation along the spatial dimensions (e.g., the height and the width), which may result in a smaller volume than the input of the pooling layer (e.g., 16×16×12 from the 32×32×12 input volume). In some examples, the machine learning model(s) 150 may not include any pooling layers. In such examples, other types of convolution layers may be used in place of pooling layers. In some examples, the layer(s) 154 may include alternating convolutional layers and pooling layers.

One or more of the layers 154 may include a fully connected layer. Each neuron in the fully connected layer(s) may be connected to each of the neurons in the previous volume. The fully connected layer may compute class scores, and the resulting volume may be 1×1×N (where N is a number of classes). In some examples, the layer(s) 154 may include a fully connected layer, while in other examples, the fully connected layer of the machine learning model(s) 150 may be the fully connected layer separate from the layer(s) 154. In some examples, no fully connected layers may be used by the layer(s) 154 and/or the machine learning model(s) 150 as a whole, in an effort to increase processing times and reduce computing resource requirements. In such examples, where no fully connected layers are used, the machine learning model(s) 150 may be referred to as a fully convolutional network.

One or more of the layers 154 may, in some examples, include a deconvolutional layer. However, the use of the term deconvolutional may be misleading and is not intended to be limiting. For example, the deconvolutional layer(s) may alternatively be referred to as transposed convolutional layers or fractionally strided convolutional layers. The deconvolutional layer(s) may be used to perform up-sampling on the output of a prior layer. For example, the deconvolutional layer(s) may be used to up-sample to a spatial resolution that is equal to the spatial resolution of the input frames to the machine learning model(s) 150, or used to up-sample to the input spatial resolution of a next layer.

Although input layers, convolutional layers, pooling layers, ReLU layers, deconvolutional layers, and fully connected layers are discussed herein with respect to the layer(s) 154, this is not intended to be limiting. For example, additional or alternative layers 154 may be used in the layer(s) 154, such as normalization layers, SoftMax layers, and/or other layer types.

Different orders and numbers of the layers 154 of the machine learning model(s) 150 may be used, depending on the examples. In addition, some of the layers 154 may include parameters (e.g., weights and/or biases) while others may not, such as the ReLU layers and pooling layers, for example. In some examples, the parameters may be learned by the machine learning model(s) 150 during training, which is described herein. Further, some of the layers 154 may include additional hyper-parameters (e.g., learning rate, stride, epochs, kernel size, number of filters, type of pooling for pooling layers, etc.)—such as the convolutional layer(s), the deconvolutional layer(s), and the pooling layer(s)—while other layers may not, such as the ReLU layer(s). Various activation functions may be used, including but not limited to, ReLU, leaky ReLU, sigmoid, hyperbolic tangent (tan h), exponential linear unit (ELU), etc. The parameters, hyper-parameters, and/or activation functions are not to be limited and may differ depending on the embodiment.

In any example, the output of the machine learning model(s) 150 may include image data 156 (which may be similar to, and/or represent, the image data 126). For instance, the image data 156 may represent one or more updated frames corresponding to the frame(s) represented by the image data 152, where the updated frame(s) is associated with one or more reaction times that are less than one or more reaction times associated with the frame(s).

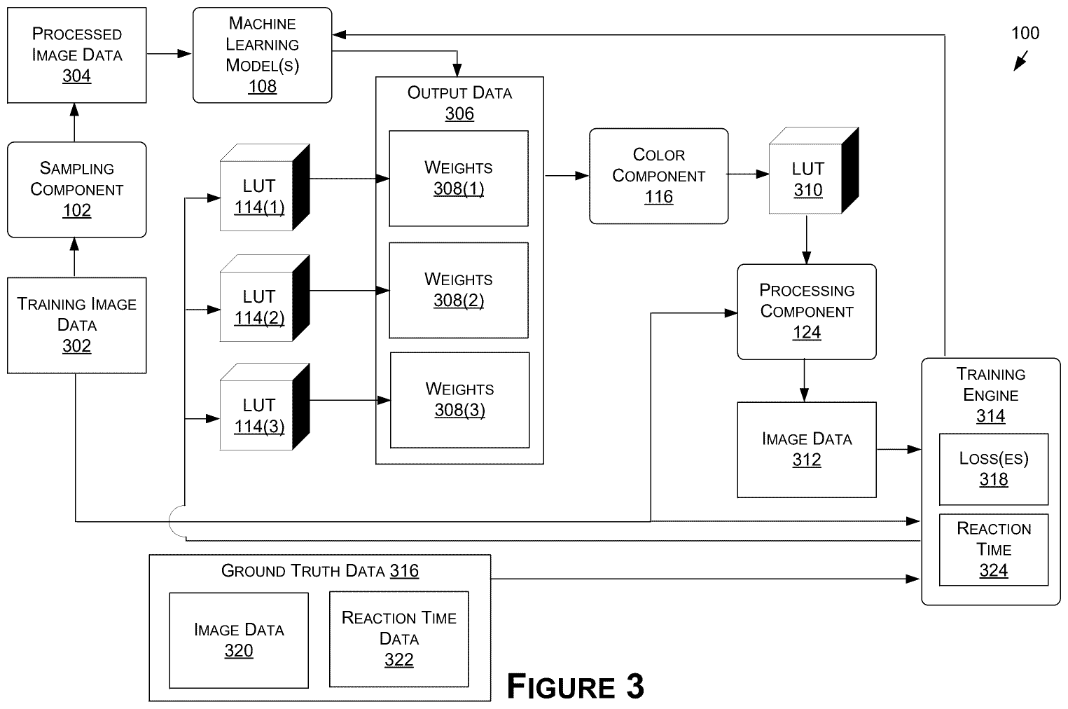

FIG. 3 illustrates an example of a process 300 of training the machine learning model(s) 108 to process frames in order to reduce reaction times associated with an application, in accordance with some embodiments of the present disclosure. As shown, the machine learning model(s) 108 may be trained using training image data 302. As described herein, the training image data 302 may represent one or more training frames associated with one or more applications. In some examples, the training image data 302 may be specific to an application for which the machine learning model(s) 108 is being trained. In some examples, the training image data 302 may include general image data that is used to train the machine learning model(s) 108 for multiple applications. In any examples, and similar to the process 100, the sampling component 102 may process the training image data 302 in order to generate processed image data 304, using one or more of the processes described herein.

The process 300 may then include the machine learning model(s) 108 processing the processed image data 304, using one or more of the processes described herein, in order to generate output data 306 (which may be similar to, and/or represent, the output data 110) representing weights 308(1)-(3) (which may be similar to, and/or represent, the weights 112). Additionally, the process 300 may include the color component 116 performing one or more of the processes described herein to generate one or more LUTs 310 associated with the training input data 302 using at least the weights 308(1)-(3) and the LUTs 114. Furthermore, the process 300 may include the processing component 124 performing one or more of the processes described herein to generate image data 312 using the training input data 302 and the LUT(s) 310, where the image data 312 represents one or more updated frames corresponding to the training frame(s) represented by the training image data 302.

As shown, the process 300 may include a training engine 314 using the training image data 302, the image data 312, and ground truth data 316 to determine one or more losses 318 associated with the training image data 302. As shown, the ground truth data 316 may include at least image data 320 representing one or more target frames corresponding to the training frame(s) represented by the training image data 302. For example, for each training frame represented by the training image data 302, the image data 320 may represent one or more corresponding target frames. As described herein, a target frame may be generated by updating one or more visual characteristics associated with a training frame. For instance, a target frame may be generated by updating one or more contrast levels, brightness levels, saturation levels, color levels, tone levels, and/or so forth associated with a training frame. In some examples, the visual characteristic(s) of the training frame may be updated to generate the target frame using one or more techniques. For example, the visual characteristic(s) may be updated in order to try and reduce a reaction time associated with the target frame as compared to the training frame. As described herein, in order to reduce the reaction time, the contrast levels, the brightness levels, and/or the saturation levels of the training frame may be increased to generate the target frame.

The training engine 314 may use one or more loss functions to determine a first loss 318 between a training frame and a target frame. As described herein, the first loss 318 may be associated with training the machine learning model(s) 108 for smoothness and/or monotonicity regularization. Additionally, any type of loss function may be used, such as cross entropy loss, mean squared error, mean absolute error, mean bias error, and/or other loss function types. Furthermore, the training engine 314 may use any technique to determine the first loss 318, such as based on a comparison of visual characteristics (e.g., pixel values) of the target frame to visual characteristics (e.g., pixel values) of the training frame. The training engine 314 may then perform similar processes to determine one or more additional first losses 318 associated with one or more additional training frames represented by the training image data 302.

As further illustrated by the example of FIG. 3, the ground truth data 316 may include reaction time data 322 representing one or more reaction times associated with one or more target frames. In some examples, one or more reaction times may be determined for a single target frame, where a respective reaction time is associated with a portion (e.g., a pixel, a group of pixels, etc.) associated with the target frame. For instance, the following equations may be used to determine a reaction time associated with a portion of a target frame:

$$RS = \frac{C}{C \cdot ( 50 + 5 f - 20 \cdot log ( lL ) ) + {10}^{0.12 + 0.09 f - 0.42 \cdot log ( L )}} \qquad ( 1 )$$

$$RT = \frac{1}{RS} \qquad ( 2 )$$

In equations (1) and (2), RS is the reaction speed, C is a contrast (e.g., a computed Michelson contrast, etc.), L is a luminance (e.g., a mean neighborhood luminance, etc.), f is a frequency, and RT is the reaction time (which is the inverse of reaction speed). In some examples, a respective reaction time may be computed for each point (e.g., each pixel) of a target frame. In some examples, reaction times may be computed for one or more (e.g., each) level of a pyramid, such as a Laplacian Pyramid.

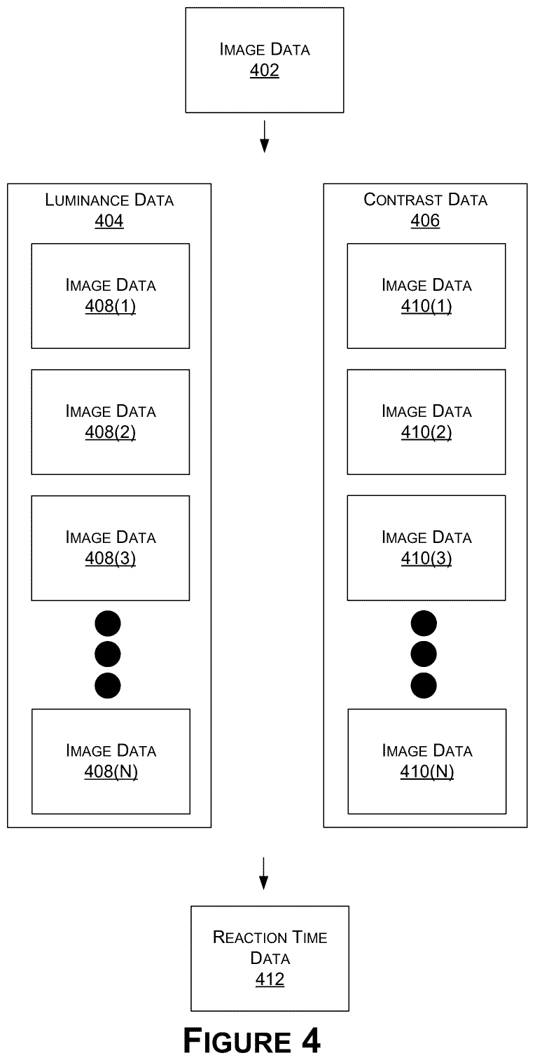

For instance, FIG. 4 illustrates an example of determining reaction times associated with a frame, in accordance with some embodiments of the present disclosure. As shown, image data 402 representing a frame may be processed in order to generate luminance data 404 associated with the frame and/or contrast data 406 associated with the frame. In some examples, the luminance data 404 may represent a Luminance Pyramid that includes image data 408(1)-(N) representing a number of frames, where the frames may be associated with different spatial frequencies. For instance, the image data 408(1) may represent a first frame associated with first luminance values corresponding to a first spatial frequency, the image data 408(2) may represent a second frame associated with second luminance values corresponding to a second spatial frequency, the image data 408(3) may represent a third frame associated with third luminance values corresponding to a third spatial frequency, and/or so forth until the image data 408(N) represents a last frame associated with last luminance values associated with a last spatial frequency.

Additionally, in some examples, the contrast data 406 may represent a Contrast Pyramid that includes image data 410(1)-(N) representing a number of frames, where the frames may be associated with different spatial frequencies. For instance, the image data 410(1) may represent a first frame associated with first contrast values (and/or first log (contrast) values) corresponding to a first spatial frequency, the image data 410(2) may represent a second frame associated with second contrast values (and/or second log (contrast) values) corresponding to a second spatial frequency, the image data 408(3) may represent a third frame associated with third contrast values (and/or third log (contrast) values) corresponding to a third spatial frequency, and/or so forth until the image data 408(N) represents a last frame associated with last contrast values (and/or last log (contrast) values) corresponding to a last spatial frequency. In some examples, the spatial frequencies associated with the luminance data 404 are similar to the spatial frequencies associated with the contrast data 406. In some examples, one or more of the spatial frequencies associated with the luminance data 404 may be different than one or more of the spatial frequencies associated with the contrast data 406.

As described herein, the luminance data 404 and the contrast data 406 may be used to generate reaction time data 412 representing one or more reaction times associated with the frame. For example, the luminance data 404 may be used to determine the luminance values and the contrast data 406 may be used to determine the contrast values that are then used to determine the reaction times, such as using one or more of the equations (1)-(2). Additionally, in some examples, the reaction time data 412 may represent a respective reaction time associated with one or more (e.g., each) point (e.g., pixel, group of pixels, etc.) associated with the frame. Furthermore, in some examples, the reaction time data 412 may represent reaction times associated with one or more (e.g., each) level of the pyramids. Similar processes may then be used to generate additional reaction time data 412 representing one or more additional reaction times associated with one or more additional frames represented by the image data 402.

Referring back to the example of FIG. 3, and for a training frame, the training engine 314 may perform one or more of the processes described herein to determine one or more reaction times 324 associated with the updated frame that corresponds to the training frame. The training engine 314 may then determine a second loss 318 using the reaction time(s) associated with the updated frame and the reaction time(s) associated with the target frame. As described herein, the second loss 318 may be associated with training the machine learning model(s) 108 to compute weights 308(1)-(3) for processing frames such that the updated frames are associated with lower reaction times. Additionally, any type of loss function may be used, such as cross entropy loss, mean squared error, mean absolute error, mean bias error, and/or other loss function types. The training engine 314 may then perform similar processes to determine one or more second losses 318 associated with one or more additional training frames represented by the training image data 302.

As further shown by the example of FIG. 3, and for a training frame, the training engine 314 may use one or more of the first loss 318 and/or the second loss 318 to update one or more parameters and/or weights of the machine learning model(s) 108 and/or update one or more of the LUTs 114. In some examples, the training engine 314 may determine a final loss 318 using the first loss 318 and the second loss 318 and then use the total loss 318 to update the parameter(s) and/or weight(s) of the machine learning model(s) 108 and/or update the LUT(s) 114. Additionally, in some examples, the training engine 314 may continue to perform these processes for one or more additional training frames represented by the training image data 302.

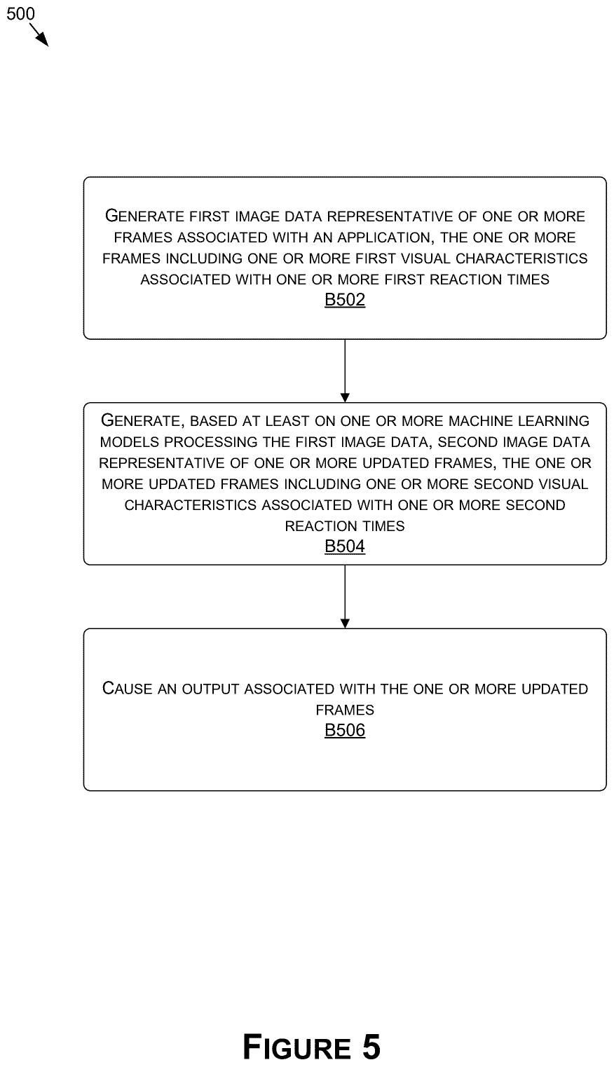

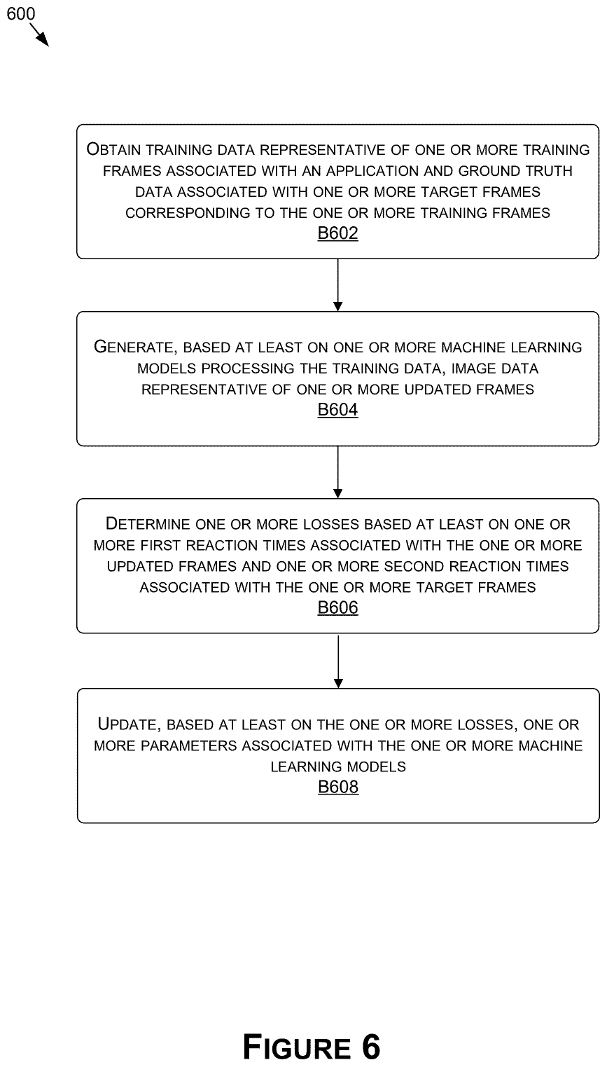

Now referring to FIGS. 5 and 6, each block of methods 500 and 600, described herein, comprises a computing process that may be performed using any combination of hardware, firmware, and/or software. For instance, various functions may be carried out by a processor executing instructions stored in memory. The methods 500 and 600 may also be embodied as computer-usable instructions stored on computer storage media. The methods 500 and 600 may be provided by a standalone application, a service or hosted service (standalone or in combination with another hosted service), or a plug-in to another product, to name a few. In addition, the methods 500 and 600 are described, by way of example, with respect to FIG. 1 and FIG. 3. However, these methods 500 and 600 may additionally or alternatively be executed by any one system, or any combination of systems, including, but not limited to, those described herein.

FIG. 5 illustrates a flow diagram showing a method 500 for using one or more machine learning models to process frames in order to reduce reaction times associated with an application, in accordance with some embodiments of the present disclosure. The method 500, at block B502, may include generating first image data representative of one or more frames associated with an application, the one or more frames including one or more first visual characteristics associated with one or more first reaction times. For instance, one or more application servers (e.g., an application server 702) may generate the image data 104 representative of the frame(s). As described herein, the application server(s) may generate the image data 104 during a session associated with the application and/or based at least on input data representing one or more inputs received using a client device (e.g., a client device 704). Additionally, the frame(s) may include the first visual characteristic(s) associated with the first reaction time(s).

The method 500, at block B504, may include generating, based at least on one or more machine learning models processing the first image data, second image data representative of one or more updated frames, the one or more updated frames including one or more second visual characteristics associated with one or more second reaction times. For instance, the machine learning model(s) 108 may process the image data 104 and, based at least on the processing, generate the image data 126 representing the updated frame(s). As described herein, the updated frame(s) includes the second visual characteristic(s) that are determined by updating the first visual characteristic(s). Additionally, the second visual characteristic(s) may be associated with the second reaction time(s), where the second reaction time(s) may be less than the first reaction time(s).

The method 500, at block B506, may include causing an output associated with the one or more updated frames. For instance, the application server(s) may cause the outputting of the updated frame(s). As described herein, the application server(s) may cause the output by sending the image data 126 to the client device, where the client device then uses the image data 126 to present (e.g., render) the updated frame(s).

FIG. 6 illustrates a flow diagram showing a method 600 for training one or more machine learning models to process frames in order to reduce reaction times associated with an application, in accordance with some embodiments of the present disclosure. The method 600, at block B602, may include obtaining training data representative of one or more training frames and ground truth data associated with one or more target frames corresponding to the one or more training frames. For instance, the training image data 302 representing the training frame(s) and the ground truth data 316 representing the data corresponding to the target frame(s) may be received. As described herein, the ground truth data 316 may include the image data 320 representing the target frame(s) and/or the reaction time data 322 representing the reaction time(s) associated with the target frame(s).

The method 600, at block B604, may include generating, based at least on one or more machine learning models processing the training data, image data representative of one or more updated frames. For instance, the machine learning model(s) 108 may process the training image data 302 and, based at least on the processing, generate the image data 312 representing the updated frame(s). As described herein, the updated frame(s) includes the visual characteristic(s) that is determined by updating the visual characteristic(s) associated with the training frame(s). For example, the update frame(s) may be generated by updating the training frame(s) using one or more of the LUTs 114.

The method 600, at block B606, may include determining one or more losses based at least on one or more first reaction times associated with the one or more updated frames and one or more second reaction times associated with the one or more target frames. For instance, the training engine 314 may determine the loss(es) 318 based at least on the first reaction time(s) determined for the updated frame(s) and the second reaction time(s) determined for the target frame(s). As described herein, the training engine 314 may determine the loss(es) 318 by at least comparing the first reaction time(s) corresponding to one or more points of the frame to the second reaction time(s) corresponding to the same point(s). In other words, the training engine 314 may determine the loss(es) 318 associated with the different point(s) of the updated frame(s).

The method 600, at block B608, may include updating, based at least on the one or more losses, one or more parameters associated with the one or more machine learning models. For instance, the training engine 314 may use the loss(es) 318 to update the parameter(s) of the machine learning model(s) 108. As described herein, in some examples, the training engine 314 may further use the loss(es) 318 to update one or more of the LUTs 114.

### Example Content Streaming System

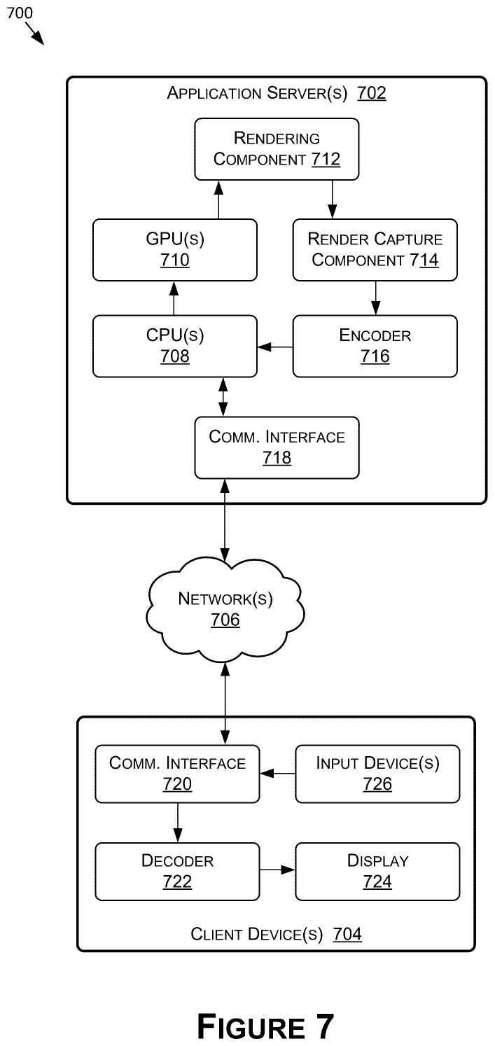

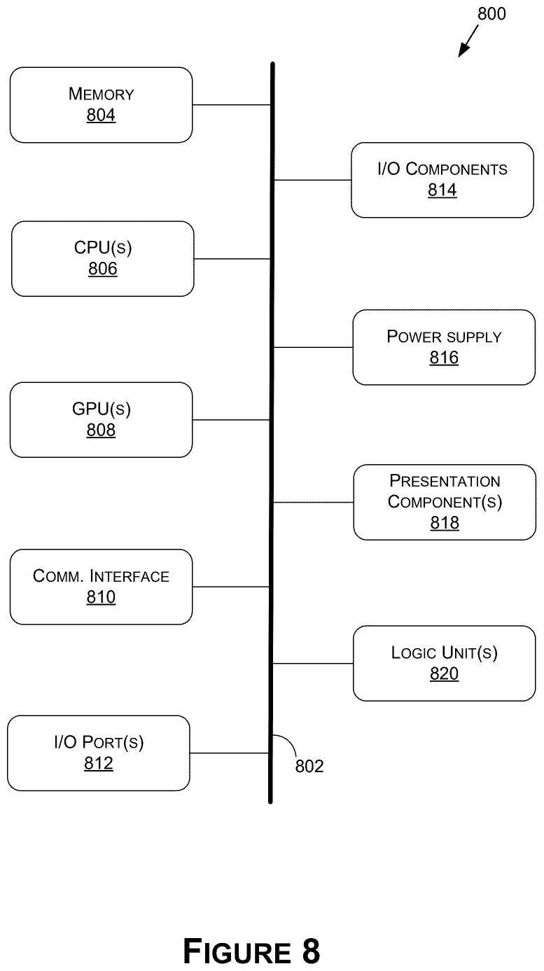

Now referring to FIG. 7, FIG. 7 is an example system diagram for a content streaming system 700, in accordance with some embodiments of the present disclosure. FIG. 7 includes application server(s) 702 (which may include similar components, features, and/or functionality to the example computing device 800 of FIG. 8), client device(s) 704 (which may include similar components, features, and/or functionality to the example computing device 800 of FIG. 8), and network(s) 706 (which may be similar to the network(s) described herein). In some embodiments of the present disclosure, the system 700 may be implemented. The application session may correspond to a game streaming application (e.g., NVIDIA GEFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types.

In the system 700, for an application session, the client device(s) 704 may only receive input data in response to inputs to the input device(s), transmit the input data to the application server(s) 702, receive encoded display data from the application server(s) 702, and display the display data on the display 724. As such, the more computationally intense computing and processing is offloaded to the application server(s) 702 (e.g., rendering—in particular ray or path tracing—for graphical output of the application session is executed by the GPU(s) of the game server(s) 702). In other words, the application session is streamed to the client device(s) 704 from the application server(s) 702, thereby reducing the requirements of the client device(s) 704 for graphics processing and rendering.

For example, with respect to an instantiation of an application session, a client device 704 may be displaying a frame of the application session on the display 724 based on receiving the display data from the application server(s) 702. The client device 704 may receive an input to one of the input device(s) and generate input data in response. The client device 704 may transmit the input data to the application server(s) 702 via the communication interface 720 and over the network(s) 706 (e.g., the Internet), and the application server(s) 702 may receive the input data via the communication interface 718. The CPU(s) may receive the input data, process the input data, and transmit data to the GPU(s) that causes the GPU(s) to generate a rendering of the application session. For example, the input data may be representative of a movement of a character of the user in a game session of a game application, firing a weapon, reloading, passing a ball, turning a vehicle, etc. The rendering component 712 may render the application session (e.g., representative of the result of the input data) and the render capture component 714 may capture the rendering of the application session as display data (e.g., as image data capturing the rendered frame of the application session). The rendering of the application session may include ray or path-traced lighting and/or shadow effects, computed using one or more parallel processing units-such as GPUs, which may further employ the use of one or more dedicated hardware accelerators or processing cores to perform ray or path-tracing techniques—of the application server(s) 702. In some embodiments, one or more virtual machines (VMs)—e.g., including one or more virtual components, such as vGPUs, vCPUs, etc.—may be used by the application server(s) 702 to support the application sessions. The encoder 716 may then encode the display data to generate encoded display data and the encoded display data may be transmitted to the client device 704 over the network(s) 706 via the communication interface 718. The client device 704 may receive the encoded display data via the communication interface 720 and the decoder 722 may decode the encoded display data to generate the display data. The client device 704 may then display the display data via the display 724.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

### Example Computing Device

FIG. 8 is a block diagram of an example computing device(s) 800 suitable for use in implementing some embodiments of the present disclosure. Computing device 800 may include an interconnect system 802 that directly or indirectly couples the following devices: memory 804, one or more central processing units (CPUs) 806, one or more graphics processing units (GPUs) 808, a communication interface 810, input/output (I/O) ports 812, input/output components 814, a power supply 816, one or more presentation components 818 (e.g., display(s)), and one or more logic units 820. In at least one embodiment, the computing device(s) 800 may comprise one or more virtual machines (VMs), and/or any of the components thereof may comprise virtual components (e.g., virtual hardware components). For non-limiting examples, one or more of the GPUs 808 may comprise one or more vGPUs, one or more of the CPUs 806 may comprise one or more vCPUs, and/or one or more of the logic units 820 may comprise one or more virtual logic units. As such, a computing device(s) 800 may include discrete components (e.g., a full GPU dedicated to the computing device 800), virtual components (e.g., a portion of a GPU dedicated to the computing device 800), or a combination thereof.

Although the various blocks of FIG. 8 are shown as connected via the interconnect system 802 with lines, this is not intended to be limiting and is for clarity only. For example, in some embodiments, a presentation component 818, such as a display device, may be considered an I/O component 814 (e.g., if the display is a touch screen). As another example, the CPUs 806 and/or GPUs 808 may include memory (e.g., the memory 804 may be representative of a storage device in addition to the memory of the GPUs 808, the CPUs 806, and/or other components). In other words, the computing device of FIG. 8 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 8.

The interconnect system 802 may represent one or more links or busses, such as an address bus, a data bus, a control bus, or a combination thereof. The interconnect system 802 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 806 may be directly connected to the memory 804. Further, the CPU 806 may be directly connected to the GPU 808. Where there is direct, or point-to-point connection between components, the interconnect system 802 may include a PCIe link to carry out the connection. In these examples, a PCI bus need not be included in the computing device 800.

The memory 804 may include any of a variety of computer-readable media. The computer-readable media may be any available media that may be accessed by the computing device 800. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 804 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 800. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 806 may be configured to execute at least some of the computer-readable instructions to control one or more components of the computing device 800 to perform one or more of the methods and/or processes described herein. The CPU(s) 806 may each include one or more cores (e.g., one, two, four, eight, twenty-eight, seventy-two, etc.) that are capable of handling a multitude of software threads simultaneously. The CPU(s) 806 may include any type of processor, and may include different types of processors depending on the type of computing device 800 implemented (e.g., processors with fewer cores for mobile devices and processors with more cores for servers). For example, depending on the type of computing device 800, the processor may be an Advanced RISC Machines (ARM) processor implemented using Reduced Instruction Set Computing (RISC) or an x86 processor implemented using Complex Instruction Set Computing (CISC). The computing device 800 may include one or more CPUs 806 in addition to one or more microprocessors or supplementary co-processors, such as math co-processors.

In addition to or alternatively from the CPU(s) 806, the GPU(s) 808 may be configured to execute at least some of the computer-readable instructions to control one or more components of the computing device 800 to perform one or more of the methods and/or processes described herein. One or more of the GPU(s) 808 may be an integrated GPU (e.g., with one or more of the CPU(s) 806 and/or one or more of the GPU(s) 808 may be a discrete GPU. In embodiments, one or more of the GPU(s) 808 may be a coprocessor of one or more of the CPU(s) 806. The GPU(s) 808 may be used by the computing device 800 to render graphics (e.g., 3D graphics) or perform general purpose computations. For example, the GPU(s) 808 may be used for General-Purpose computing on GPUs (GPGPU). The GPU(s) 808 may include hundreds or thousands of cores that are capable of handling hundreds or thousands of software threads simultaneously. The GPU(s) 808 may generate pixel data for output images in response to rendering commands (e.g., rendering commands from the CPU(s) 806 received via a host interface). The GPU(s) 808 may include graphics memory, such as display memory, for storing pixel data or any other suitable data, such as GPGPU data. The display memory may be included as part of the memory 804. The GPU(s) 808 may include two or more GPUs operating in parallel (e.g., via a link). The link may directly connect the GPUs (e.g., using NVLINK) or may connect the GPUs through a switch (e.g., using NVSwitch). When combined together, each GPU 808 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 806 and/or the GPU(s) 808, the logic unit(s) 820 may be configured to execute at least some of the computer-readable instructions to control one or more components of the computing device 800 to perform one or more of the methods and/or processes described herein. In embodiments, the CPU(s) 806, the GPU(s) 808, and/or the logic unit(s) 820 may discretely or jointly perform any combination of the methods, processes and/or portions thereof. One or more of the logic units 820 may be part of and/or integrated in one or more of the CPU(s) 806 and/or the GPU(s) 808 and/or one or more of the logic units 820 may be discrete components or otherwise external to the CPU(s) 806 and/or the GPU(s) 808. In embodiments, one or more of the logic units 820 may be a coprocessor of one or more of the CPU(s) 806 and/or one or more of the GPU(s) 808.

Examples of the logic unit(s) 820 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 810 may include one or more receivers, transmitters, and/or transceivers that enable the computing device 800 to communicate with other computing devices via an electronic communication network, included wired and/or wireless communications. The communication interface 810 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 820 and/or communication interface 810 may include one or more data processing units (DPUs) to transmit data received over a network and/or through interconnect system 802 directly to (e.g., a memory of) one or more GPU(s) 808.

The I/O ports 812 may enable the computing device 800 to be logically coupled to other devices including the I/O components 814, the presentation component(s) 818, and/or other components, some of which may be built in to (e.g., integrated in) the computing device 800. Illustrative I/O components 814 include a microphone, mouse, keyboard, joystick, game pad, game controller, satellite dish, scanner, printer, wireless device, etc. The I/O components 814 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 800. The computing device 800 may be include depth cameras, such as stereoscopic camera systems, infrared camera systems, RGB camera systems, touchscreen technology, and combinations of these, for gesture detection and recognition. Additionally, the computing device 800 may include accelerometers or gyroscopes (e.g., as part of an inertia measurement unit (IMU)) that enable detection of motion. In some examples, the output of the accelerometers or gyroscopes may be used by the computing device 800 to render immersive augmented reality or virtual reality.

The power supply 816 may include a hard-wired power supply, a battery power supply, or a combination thereof. The power supply 816 may provide power to the computing device 800 to enable the components of the computing device 800 to operate.

The presentation component(s) 818 may include a display (e.g., a monitor, a touch screen, a television screen, a heads-up-display (HUD), other display types, or a combination thereof), speakers, and/or other presentation components. The presentation component(s) 818 may receive data from other components (e.g., the GPU(s) 808, the CPU(s) 806, DPUs, etc.), and output the data (e.g., as an image, video, sound, etc.).

### Example Data Center

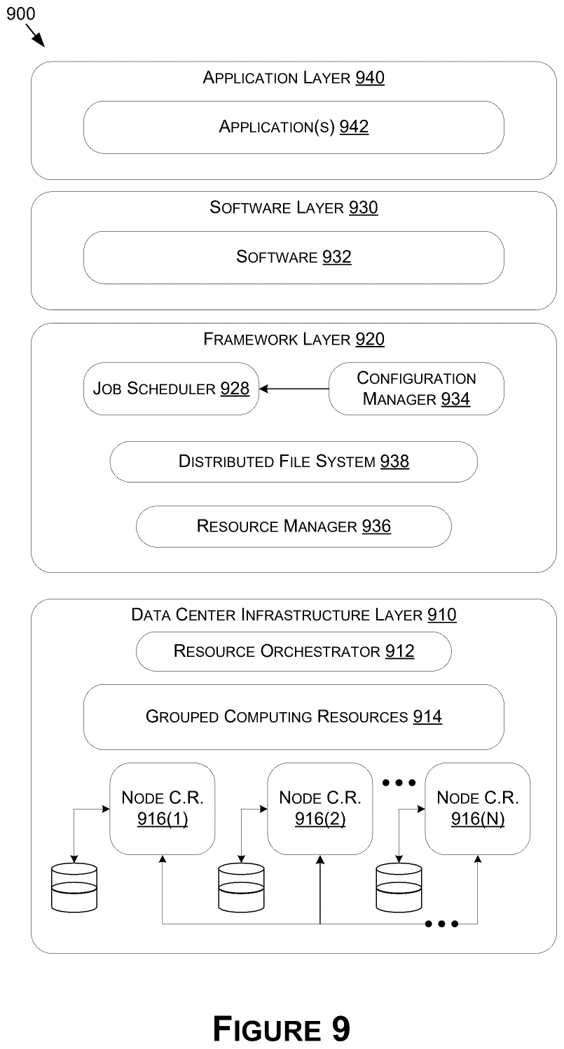

FIG. 9 illustrates an example data center 900 that may be used in at least one embodiments of the present disclosure. The data center 900 may include a data center infrastructure layer 910, a framework layer 920, a software layer 930, and/or an application layer 940.

As shown in FIG. 9, the data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 916(1)-916(N) may correspond to a server having one or more of the above-mentioned computing resources. In addition, in some embodiments, the node C.R.s 916(1)-9161(N) may include one or more virtual components, such as vGPUs, vCPUs, and/or the like, and/or one or more of the node C.R.s 916(1)-916(N) may correspond to a virtual machine (VM).

In at least one embodiment, grouped computing resources 914 may include separate groupings of node C.R.s 916 housed within one or more racks (not shown), or many racks housed in data centers at various geographical locations (also not shown). Separate groupings of node C.R.s 916 within grouped computing resources 914 may include grouped compute, network, memory or storage resources that may be configured or allocated to support one or more workloads. In at least one embodiment, several node C.R.s 916 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 912 may configure or otherwise control one or more node C.R.s 916(1)-916(N) and/or grouped computing resources 914. In at least one embodiment, resource orchestrator 912 may include a software design infrastructure (SDI) management entity for the data center 900. The resource orchestrator 912 may include hardware, software, or some combination thereof.

In at least one embodiment, as shown in FIG. 9, framework layer 920 may include a job scheduler 928, a configuration manager 934, a resource manager 936, and/or a distributed file system 938. The framework layer 920 may include a framework to support software 932 of software layer 930 and/or one or more application(s) 942 of application layer 940. The software 932 or application(s) 942 may respectively include web-based service software or applications, such as those provided by Amazon Web Services, Google Cloud and Microsoft Azure. The framework layer 920 may be, but is not limited to, a type of free and open-source software web application framework such as Apache Spark™ (hereinafter “Spark”) that may utilize distributed file system 938 for large-scale data processing (e.g., “big data”). In at least one embodiment, job scheduler 928 may include a Spark driver to facilitate scheduling of workloads supported by various layers of data center 900. The configuration manager 934 may be capable of configuring different layers such as software layer 930 and framework layer 920 including Spark and distributed file system 938 for supporting large-scale data processing. The resource manager 936 may be capable of managing clustered or grouped computing resources mapped to or allocated for support of distributed file system 938 and job scheduler 928. In at least one embodiment, clustered or grouped computing resources may include grouped computing resource 914 at data center infrastructure layer 910. The resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920. One or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. Self-modifying actions may relieve a data center operator of data center 900 from making possibly bad configuration decisions and possibly avoiding underutilized and/or poor performing portions of a data center.

The data center 900 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 900. In at least one embodiment, trained or deployed machine learning models corresponding to one or more neural networks may be used to infer or predict information using resources described above with respect to the data center 900 by using weight parameters calculated through one or more training techniques, such as but not limited to those described herein.

In at least one embodiment, the data center 900 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 800 of FIG. 8—e.g., each device may include similar components, features, and/or functionality of the computing device(s) 800. In addition, where backend devices (e.g., servers, NAS, etc.) are implemented, the backend devices may be included as part of a data center 900, an example of which is described in more detail herein with respect to FIG. 9.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 800 described herein with respect to FIG. 8. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A: A method comprising: applying, to one or more machine learning models, first image data representative of one or more frames associated with an interactive application, the one or more frames including one or more visual characteristics associated with one or more first reaction times; generating, based at least on the one or more machine learning models processing the first image data, second image data representative of one or more updated frames, the one or more updated frames including one or more updated visual characteristics associated with one or more second reaction times that are less than the one or more first reaction times; and causing an output of the one or more updated frames represented by the second image data.

B: The method of paragraph A, wherein: the one or more visual characteristics associated with the one or more first reaction times include at least one of one or more first luminance values or one or more first contrast values associated with one or more pixels of the one or more frames; and the one or more updated visual characteristics associated with the one or more second reaction times include at least one of one or more second luminance values or one or more second contrast values associated with the one or more frames.

C: The method of either paragraph A or paragraph B, wherein the generating the second image data comprises: determining, based at least on the one or more machine learning models processing the first image data, one or more weights associated with one or more first color lookup tables; and determining a second color lookup table based at least on the one or more weights and the one or more first color lookup tables; and generating the second image data by applying one or more values of the second color lookup table to one or more pixels of the one or more frames represented by the first image data.

D: The method of any one of paragraphs A-C, wherein the generating the second image data comprises: determining, based at least on the one or more machine learning models processing the first image data, one or more weights associated with one or more lookup tables; and generating the second image data by applying, based at least on the one or more weights, the one or more lookup tables to one or more pixels of the one or more frames represented by the first image data.

E: The method of any one of paragraphs A-D, further comprising: applying, to the one or more machine learning models, third image data representative of one or more second frames associated with the interactive application, the one or more second frames including one or more second visual characteristics associated with one or more third reaction times; generating, based at least on the one or more machine learning models processing the third image data, fourth image data representative of one or more updated second frames, the one or more updated second frames including one or more second updated visual characteristics associated with one or more fourth reaction times that are less than the one or more third reaction times; and causing an output of the one or more second updated frames represented by the fourth image data.

F: The method of paragraph E, wherein the generating the fourth image data comprises: determining, based at least on the one or more machine learning models processing the first image data, one or more first weights associated with one or more color lookup tables; determining, based at least on the one or more machine learning models processing the third image data, one or more second weights associated with the one or more color lookup tables; determining one or more third weights based at least on the one or more first weights, the one or more second weights, and the color value; and generating the fourth image data based at least on the third image data, the one or more third weights, and the one or more lookup tables.

G: The method of any one of paragraphs A-F, wherein the one or more machine learning models are updated, at least, by: generating, based at least on the one or more machine learning models processing third image data representative of one or more second frames, fourth image data representative of one or more updated second frames; determining one or more third reaction times associated with the one or more updated second frames; determining one or more fourth reaction times associated with one or more target frames corresponding to the one or more second frames; determining one or more loss values corresponding to one or more loss functions based at least on the one or more third reaction times and the one or more fourth reaction times; and updating, based at least on the one or more loss values, one or more parameters of the one or more machine learning models.

H: The method of paragraph G, wherein: the determining the one or more third reaction times is based at least on one or more second visual characteristics associated with the one or more second frames; and the determining the one or more fourth reaction times is based at least on one or more updated second visual characteristics associated with the one or more updated second frames.

I: The method of any one of paragraphs A-H, wherein the one or more machine learning models are updated, at least, by: generating, based at least on the one or more machine learning models processing third image data representative of one or more second frames, fourth image data representative of one or more updated second frames; determining one or more losses based at least on analyzing the one or more second frames with respect to one or more target frames; and updating, based at least on the one or more losses, one or more parameters of the one or more machine learning models.

J: The method of any one of paragraph A-I, wherein the causing the output of the one or more updated frames comprises one or more of: sending the second image data to one or more client devices for output by the one or more client devices; or displaying, using a client device, the one or more updated frames represented by the second image data.

K: A system comprising: one or more processors to: obtain first image data representative of one or more frames associated with an application, the one or more frames including one or more visual characteristics associated with one or more first reaction times; generate, based at least on one or more machine learning models processing the first image data, second image data representative of one or more updated frames, the one or more updated frames including one or more updated visual characteristics associated with one or more second reaction times that are less than the one or more first reaction times; and transmit the second image data to a client device.

L: The system of paragraph K, wherein: the one or more visual characteristics associated with the one or more first reaction times include at least one of one or more first luminance values or one or more first contrast values associated with one or more pixels of the one or more frames; and the one or more updated visual characteristics associated with the one or more second reaction times include at least one value of one or more second luminance values or one or more second contrast values associated with the one or more pixels.

M: The system of either paragraph K or paragraph L, wherein the generation of the second image data comprises: determining, based at least on the one or more machine learning models processing the first image data, one or more weights associated with one or more first color lookup tables; determining a second color lookup table based at least on the one or more weights and the one or more first color lookup tables; and generating the second image data by applying one or more values of the second color lookup table to one or more pixels of the one or more frames represented by the first image data.

N: The system of any one of paragraphs K-M, wherein the one or more processors are further to: obtain third image data representative of one or more second frames associated with the application, the one or more second frames including one or more second visual characteristics associated with one or more third reaction times; generate, based at least on the one or more machine learning models processing the third image data, fourth image data representative of one or more updated second frames, the one or more updated second frames including one or more updated second visual characteristics associated with one or more fourth reaction times that are less than the one or more third reaction times; and transmit the fourth image data to the client device.

O: The system of paragraph N, wherein the one or more processors are further to: determine, based at least on the one or more visual characteristics and the one or more second visual characteristics, a color value associated with the one or more second frames, wherein the generation of the fourth image data is further based at least on the color value.

P: The system of paragraph O, wherein the generation of the fourth image data comprises: determining, based at least on the one or more machine learning models processing the first image data, one or more first weights associated with one or more color lookup tables comprising one or more values corresponding to at least one visual characteristic of the first image data; determining, based at least on the one or more machine learning models processing the third image data, one or more second weights associated with the one or more color lookup tables; determining one or more third weights based at least on the one or more first weights, the one or more second weights, and the color value; and generating the fourth image data based at least on the third image data, the one or more third weights, and the one or more lookup tables.

Q: The system of any one paragraphs K-P, wherein the one or more machine learning models are updated, at least, by: generating, based at least on the one or more machine learning models processing third image data representative of one or more second frames, fourth image data representative of one or more updated second frames; determining one or more third reaction times associated with the one or more updated second frames; determining one or more fourth reaction times associated with one or more target frames corresponding to the one or more second frames; determining one or more loss values corresponding to one or more loss functions based at least on the one or more third reaction times and the one or more fourth reaction times; and updating, based at least on the one or more loss values, one or more parameters of the one or more machine learning models.

R: The system of any one of paragraphs K-Q, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

S: One or more processors comprising: processing circuitry to generate, based at least on one or more machine learning models processing image data representative of one or more frames, updated image data representative of one or more updated frames that include one or more visual characteristics associated with a reaction time that is less than a reaction time associated with the one or more frames, and causing an output of the one or more updated frames represented by the updated image data.

T: The one or more processors of paragraph S, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

What is claimed is:

1. A method comprising:
applying, to one or more machine learning models, first image data representative of one or more frames associated with an interactive application, the one or more frames including one or more visual characteristics associated with one or more first reaction times;
generating, based at least on the one or more machine learning models processing the first image data, second image data representative of one or more updated frames, the one or more updated frames including one or more updated visual characteristics associated with one or more second reaction times that are less than the one or more first reaction times; and
causing an output of the one or more updated frames represented by the second image data.

2. The method of claim 1, wherein:
the one or more visual characteristics associated with the one or more first reaction times include at least one of one or more first luminance values or one or more first contrast values associated with one or more pixels of the one or more frames; and
the one or more updated visual characteristics associated with the one or more second reaction times include at least one of one or more second luminance values or one or more second contrast values associated with the one or more frames.

3. The method of claim 1, wherein the generating the second image data comprises:
determining, based at least on the one or more machine learning models processing the first image data, one or more weights associated with one or more first color lookup tables; and
determining a second color lookup table based at least on the one or more weights and the one or more first color lookup tables; and
generating the second image data by applying one or more values of the second color lookup table to one or more pixels of the one or more frames represented by the first image data.

4. The method of claim 1, wherein the generating the second image data comprises:
determining, based at least on the one or more machine learning models processing the first image data, one or more weights associated with one or more lookup tables; and
generating the second image data by applying, based at least on the one or more weights, the one or more lookup tables to one or more pixels of the one or more frames represented by the first image data.

5. The method of claim 1, further comprising:
applying, to the one or more machine learning models, third image data representative of one or more second frames associated with the interactive application, the one or more second frames including one or more second visual characteristics associated with one or more third reaction times;
generating, based at least on the one or more machine learning models processing the third image data, fourth image data representative of one or more updated second frames, the one or more updated second frames including one or more second updated visual characteristics associated with one or more fourth reaction times that are less than the one or more third reaction times; and
causing an output of the one or more second updated frames represented by the fourth image data.

6. The method of claim 5, wherein the generating the fourth image data comprises:
determining, based at least on the one or more machine learning models processing the first image data, one or more first weights associated with one or more color lookup tables;
determining, based at least on the one or more machine learning models processing the third image data, one or more second weights associated with the one or more color lookup tables;
determining one or more third weights based at least on the one or more first weights, the one or more second weights, and the color value; and
generating the fourth image data based at least on the third image data, the one or more third weights, and the one or more lookup tables.

7. The method of claim 1, wherein the one or more machine learning models are updated, at least, by:
generating, based at least on the one or more machine learning models processing third image data representative of one or more second frames, fourth image data representative of one or more updated second frames;
determining one or more third reaction times associated with the one or more updated second frames;
determining one or more fourth reaction times associated with one or more target frames corresponding to the one or more second frames;
determining one or more loss values corresponding to one or more loss functions based at least on the one or more third reaction times and the one or more fourth reaction times; and
updating, based at least on the one or more loss values, one or more parameters of the one or more machine learning models.

8. The method of claim 7, wherein:
the determining the one or more third reaction times is based at least on one or more second visual characteristics associated with the one or more second frames; and
the determining the one or more fourth reaction times is based at least on one or more updated second visual characteristics associated with the one or more updated second frames.

9. The method of claim 1, wherein the one or more machine learning models are updated, at least, by:
generating, based at least on the one or more machine learning models processing third image data representative of one or more second frames, fourth image data representative of one or more updated second frames;
determining one or more losses based at least on analyzing the one or more second frames with respect to one or more target frames; and
updating, based at least on the one or more losses, one or more parameters of the one or more machine learning models.

10. The method of claim 1, wherein the causing the output of the one or more updated frames comprises one or more of:
sending the second image data to one or more client devices for output by the one or more client devices; or
displaying, using a client device, the one or more updated frames represented by the second image data.

11. A system comprising:
one or more processors to:
obtain first image data representative of one or more frames associated with an application, the one or more frames including one or more visual characteristics associated with one or more first reaction times;
generate, based at least on one or more machine learning models processing the first image data, second image data representative of one or more updated frames, the one or more updated frames including one or more updated visual characteristics associated with one or more second reaction times that are less than the one or more first reaction times; and
transmit the second image data to a client device.

12. The system of claim 11, wherein:
the one or more visual characteristics associated with the one or more first reaction times include at least one of one or more first luminance values or one or more first contrast values associated with one or more pixels of the one or more frames; and
the one or more updated visual characteristics associated with the one or more second reaction times include at least one value of one or more second luminance values or one or more second contrast values associated with the one or more pixels.

13. The system of claim 11, wherein the generation of the second image data comprises:
determining, based at least on the one or more machine learning models processing the first image data, one or more weights associated with one or more first color lookup tables;
determining a second color lookup table based at least on the one or more weights and the one or more first color lookup tables; and
generating the second image data by applying one or more values of the second color lookup table to one or more pixels of the one or more frames represented by the first image data.

14. The system of claim 11, wherein the one or more processors are further to:
obtain third image data representative of one or more second frames associated with the application, the one or more second frames including one or more second visual characteristics associated with one or more third reaction times;
generate, based at least on the one or more machine learning models processing the third image data, fourth image data representative of one or more updated second frames, the one or more updated second frames including one or more updated second visual characteristics associated with one or more fourth reaction times that are less than the one or more third reaction times; and
transmit the fourth image data to the client device.

15. The system of claim 14, wherein the one or more processors are further to:
determine, based at least on the one or more visual characteristics and the one or more second visual characteristics, a color value associated with the one or more second frames,
wherein the generation of the fourth image data is further based at least on the color value.

16. The system of claim 15, wherein the generation of the fourth image data comprises:
determining, based at least on the one or more machine learning models processing the first image data, one or more first weights associated with one or more color lookup tables comprising one or more values corresponding to at least one visual characteristic of the first image data;
determining, based at least on the one or more machine learning models processing the third image data, one or more second weights associated with the one or more color lookup tables;
determining one or more third weights based at least on the one or more first weights, the one or more second weights, and the color value; and
generating the fourth image data based at least on the third image data, the one or more third weights, and the one or more lookup tables.

17. The system of claim 11, wherein the one or more machine learning models are updated, at least, by:
generating, based at least on the one or more machine learning models processing third image data representative of one or more second frames, fourth image data representative of one or more updated second frames;
determining one or more third reaction times associated with the one or more updated second frames;
determining one or more fourth reaction times associated with one or more target frames corresponding to the one or more second frames;
determining one or more loss values corresponding to one or more loss functions based at least on the one or more third reaction times and the one or more fourth reaction times; and
updating, based at least on the one or more loss values, one or more parameters of the one or more machine learning models.

18. The system of claim 11, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

19. One or more processors comprising:
processing circuitry to generate, based at least on one or more machine learning models processing image data representative of one or more frames, updated image data representative of one or more updated frames that include one or more visual characteristics associated with a reaction time that is less than a reaction time associated with the one or more frames, and causing an output of the one or more updated frames represented by the updated image data.

20. The one or more processors of claim 19, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
